(19) United States
(12) Patent Application Publication
(10) Pub. No.: US 2026/0230470 A1
(43) Pub. Date: Aug. 6, 2026

(54) AUTHENTICATION USING AUGMENTED REALITY FACIAL EXPRESSION AND BODY MOTION TRACKING

(71) Applicant: Visa International Service Association, San Francisco, CA (US)

(72) Inventors: SANTOSH KUMAR KVS, Hyderabad (IN); AMRENDRA NARAYAN JHA, Madhubani (IN); Avi BOMB, Chennai (IN); Madhusmita MOHAPATRA, Bangalore (IN); Rakesh RAMAMURTHY, Bangalore (IN)

(73) Assignee: Visa International Service Association, San Francisco, CA (US)

(21) Appl. No.: 19/149,549

(22) PCT Filed: Feb. 1, 2023
(86) PCT No.: PCT/US2023/012131

§ 371 Date: Jul. 20, 2025

(51) Int. Cl. H04L 9/40; G06V 20/20; G06V 40/16

(52) U.S. Cl. CPC H04L 63/0861; G06V 20/20; G06V 40/172; G06V 40/174

(57) ABSTRACT

In some embodiments, a systemincludes a processor and a non-transitory computer readable medium coupled to the processor, wherein the non-transitory computer readable medium includes code that: requests a comparison user expression from a user of an application of a user device; maps the comparison user expression to a comparison blend shape coefficient and a comparison blend shape coefficient value at the authentication server; requests from the authentication server, an authentication user expression from the user of the application on the user device; maps the authentication user expression to an authentication blend shape coefficient and an authentication blend shape coefficient value at the authentication server; and utilizes the authentication user expression and the comparison user expression to authenticate the user of the user device.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

With fintech mobile solutions rapidly growing in popularity, second factor authentication has become increasingly important in authenticating users of mobile device applications. Traditional application authentication methods, such as, one-time password (OTP) or dual-authentication methods, pose unique challenges based on, for example, the geography of the user of the application and local regulations imposed by local governments. For specially-abled users of applications, safety issues associated with existing authentication methods may be of particularly importance, since there is a greater chance of specially-abled users being taken advantage of during the authentication process. Therefore, a need exists to improve upon existing authentication applications.

### BRIEF DESCRIPTION OF THE DRAWINGS

FIG. 1A illustrates a block diagram of a system in accordance with some embodiments.

FIG. 1B illustrates a block diagram of an authentication network that includes the system of FIG. 1A in accordance with some embodiments.

FIG. 2 illustrates a block diagram of a user expression-based authentication unit of the system in FIG. 1A in accordance with some embodiments.

FIG. 3 is a flow diagram illustrating a user expression-based mapping method in accordance with some embodiments.

FIG. 4 is a flow diagram illustrating a user expression-based authentication method in accordance with some embodiments.

FIG. 5A illustrates a user expression blend shape coefficient table in accordance with some embodiments.

FIG. 5B illustrates a continuation of the user expression blend shape coefficient table of FIG. 5A in accordance with some embodiments.

FIG. 6 illustrates a sequence of images of a left eye blink user expression of a user utilized in performing the user expression-based authentication method of FIG. 4 in accordance with some embodiments.

FIG. 7 illustrates a sequence of images of a jaw open user expression of a user utilized in performing the user expression-based authentication method of FIG. 4 in accordance with some embodiments.

### DETAILED DESCRIPTION

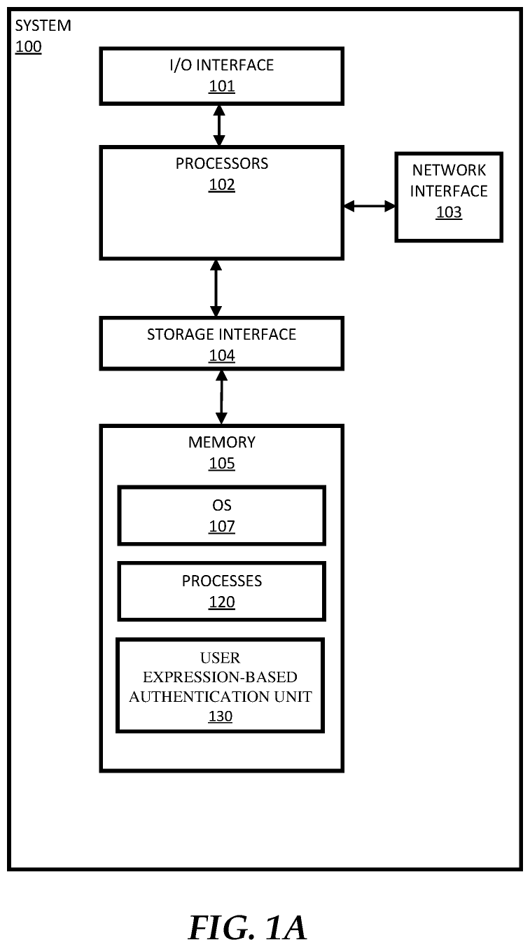

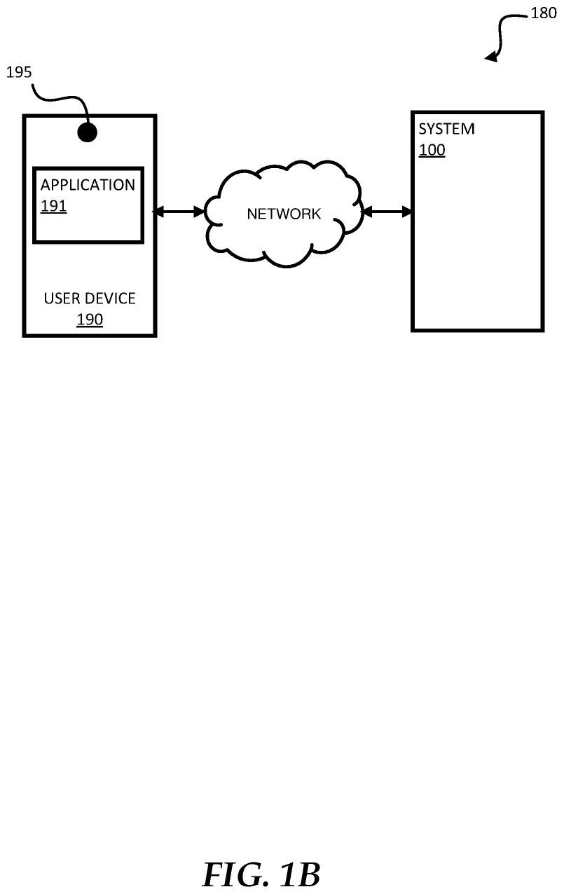

FIG. 1A illustrates a block diagram of an exemplary system 100 for implementing embodiments consistent with the present disclosure. In some embodiments, the system 100 includes an input/output (IO) interface 101, processor/s 102, a storage interface 104, a network interface 103, and memory 105. In some embodiments, the system 100 may be, for example, a server, such as an authentication server utilized to implement the embodiments described herein. In some embodiments, memory 105 may include an operating system (OS) 107, processes 120, and a user expression-based authentication unit 130. In some nonlimiting embodiments or aspects, the system 100 provides a user expression-based authentication unit 130 that is configured to implement a user expression-based authentication method configured to authenticate a user of a user device as described further herein.

In some embodiments, the processors 102 may comprise at least one data processor for executing program components for dynamic resource allocation at run time. The processors 102 may include specialized processing units such as integrated system (bus) controllers, memory management control units, floating point units, graphics processing units, digital signal processing units, etc. In some embodiments, the processors 102 may be disposed in communication with one or more input/output (I/O) devices (not shown) via an I/O interface 101. The I/O interface 101 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMi), RF antennas, S-Video, VGA, IEEE 802.1 n/b/g/n/x, Bluetooth®, cellular (e.g., code-division multiple access (CDMA), high-speed packet access (HSPA+), global system for mobile communications (GSM), long-term evolution (LTE), WiMax®), or the like), etc.

In some embodiments, using the I/O interface 101, the system 100 may communicate with one or more I/O devices. For example, an input device (not shown) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device (not shown) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processors 102 may be disposed in communication with a communication network or other type of network via a network interface 103. The network interface 103 may communicate with the communication network. The network interface 103 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network may include, without limitation, a direct interconnection, e-commerce network, a peer to peer (P2P) network, local area network (LAN), wide area network (WAN), wireless network (e.g., using Wireless Application Protocol), the internet, Wi-Fi®, etc. Using the network interface 103 and the communication network, the system 100 may communicate with the one or more service operators.

In some non-limiting embodiments or aspects, the processors 102 may be disposed in communication with a memory 105 (e.g., RAM, ROM, etc.) via a storage interface 104. In some embodiments, the storage interface 104 may connect to memory 105 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc.

In some embodiments, the memory 105 may store a collection of program or database components, including, without limitation, a user interface, an operating system 107, a web server, etc. In some non-limiting embodiments or aspects, the system 100 may store user/application data, such as the data, variables, records, etc. as described in this disclosure. Such databases may be implemented as fault-tolerant, relational, scalable, secure databases such as Oracle or Sybase.

In some embodiments, the operating system 107 may facilitate resource management and operation of the system 100. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® OS®, GOOGLE™ ANDROID™, BLACKBERRY® OS, or the like.

In some non-limiting embodiments or aspects, the system 100 may implement a web browser (not shown in the figures) stored program component. The web browser (not shown in the figures) may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, ADOBE® FLASH®, JAVASCRIPT®, JAVA®, Application Programming Interfaces (APIs), etc.

Furthermore, one or more computer-readable storage media may be utilized in implementing embodiments consistent with the present disclosure. In some embodiments, a computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

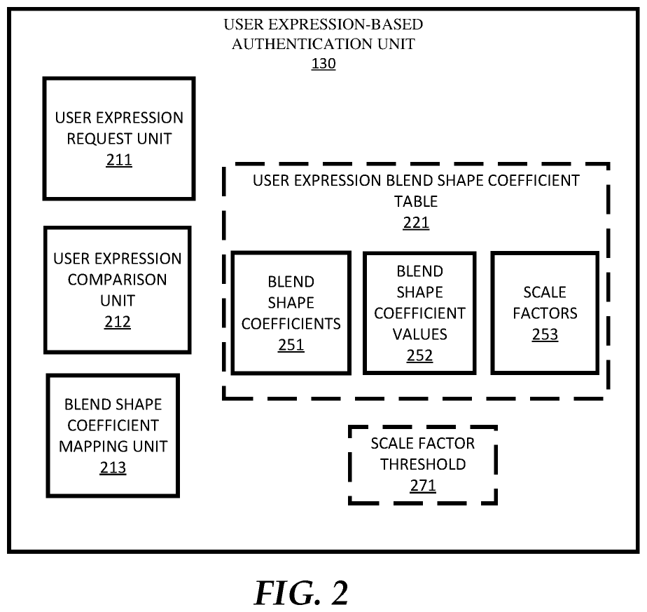

FIG. 1B illustrates a block diagram of an authentication network 180 in accordance with some embodiments. In some embodiments, the authentication network 180 is configured to utilize the system 100 as an authentication server to authenticate a user of an application 191 on a user device 190. In some embodiments, the authentication network 180 includes the user device 190 communicatively coupled to system 100 via a communication network. In some embodiments, the user device 190 may be computer system having a configuration similar to that of system 100 of FIG. 1A (excluding the user expression-based authentication unit 130) and may be a mobile phone, tablet, or other type of computer system. In some embodiments, the user device 190 includes a capturing device 195, such as a camera, and the application 191. In some embodiments, the application 191 is a software application configured to perform at least a portion of the operations described herein. In some embodiments, the application 191, may be, for example, a fintech application configured to utilize the methods described herein to authenticate the user of the user device 190. In some embodiments, system 100 is an authentication server configured to authenticate the user of user device 190 using the methods described further herein with reference to FIG. 2-FIG. 7.

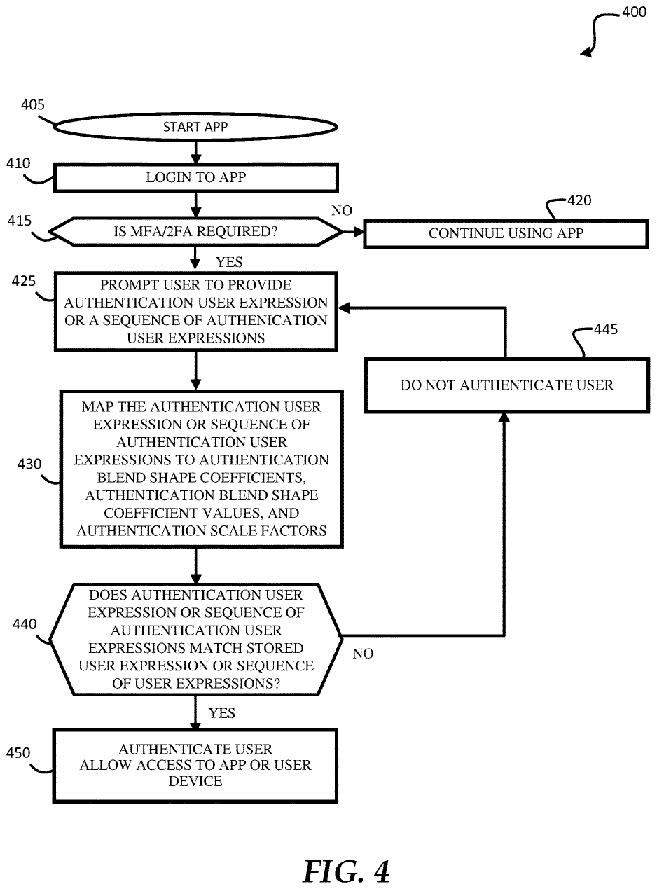

FIG. 2 illustrates a block diagram of the user expression-based authentication unit 130 of FIG. 1A in accordance with some embodiments. In some embodiments, the user expression-based authentication unit 130 is executable code configured to authenticate a user of an application 191 utilizing a user expression or a sequence of user expressions captured of the user of the user device 190. In some embodiments, the user expression may be an expression or motion of the user of the user device 190 that is captured utilizing a capturing device 195 on user device 190 and provided to an authentication server for authentication of the user for use of application 191 or user device 190. In some embodiments, for example, the user expression may be a facial expression of the user (e.g., a smile, a frown, etc.) or a motion of the user (e.g., a movement of the body, etc.) captured by the capturing device 195. In some embodiments, the user expression-based authentication unit 130 is configured to map or encode the user expressions to blend shape coefficients and blend shape coefficient values in memory 105 (described further in detail herein) and utilize the user expressions and blend shape coefficient values to authenticate the user of the user device 190 (as illustrated by way of example in FIG. 4).

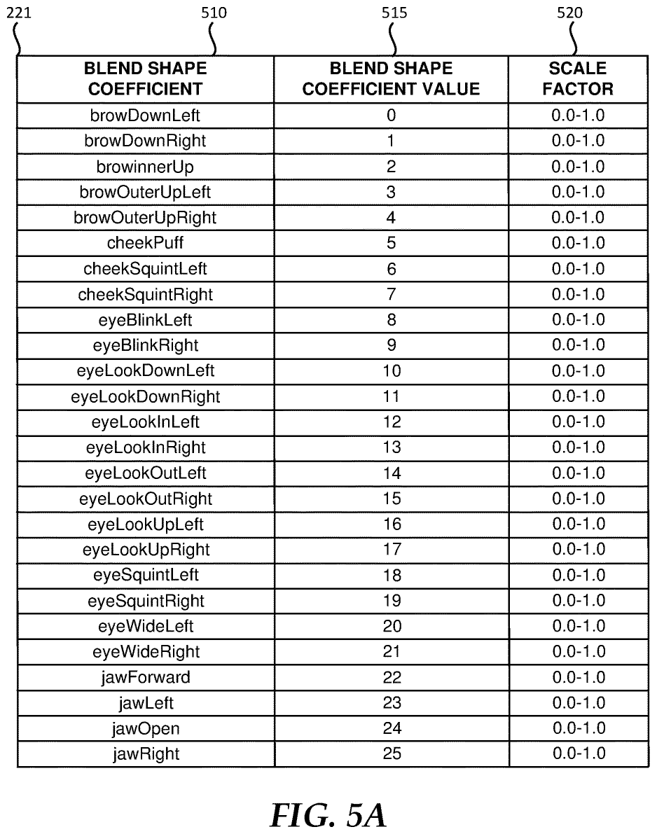

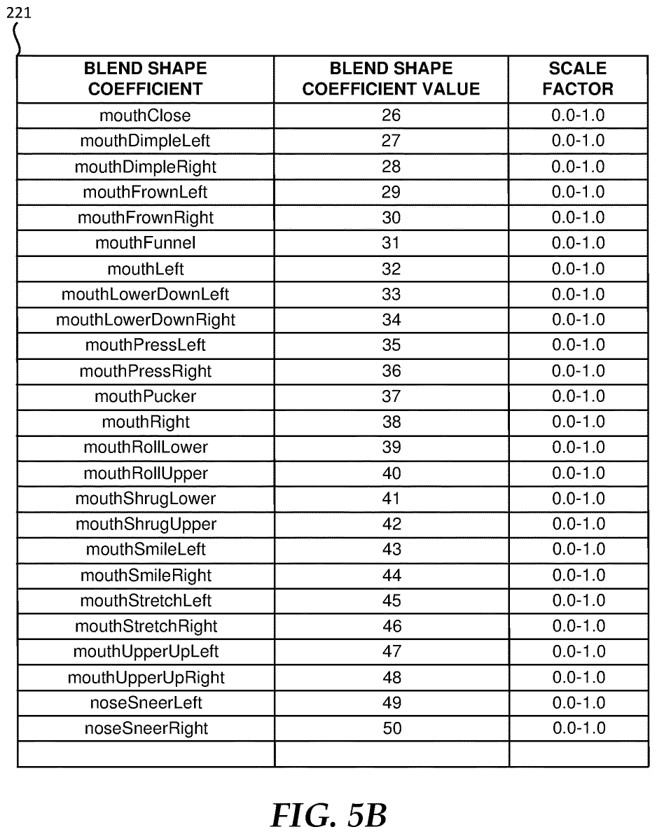

In some embodiments, the user expression-based authentication unit 130 includes a user expression request unit 211, a user expression comparison unit 212, and a blend shape coefficient mapping unit 213. In some embodiments, the user expression request unit 211 is executable code configured to request user expressions or a sequence of user expressions from the user of a user device 190 for storage in memory 105. In some embodiments, each type of user expression associated with the user is stored in a user expression blend shape coefficient table 221 of memory 105 (illustrated by way of example in FIG. 5A and FIG. 5B). In some embodiments, the user expression blend shape coefficient table 221 includes user expressions mapped to blend shape coefficients 251, blend shape coefficient values 252, and scale factors 253. In some embodiments, a blend shape coefficient in the blend shape coefficients 251 is a named representation of a user expression expressed by the user of the user device 190. In some embodiments, a blend shape coefficient value of blend shape coefficient values 252 is a numerical value assigned by blend shape coefficient mapping unit 213 to the blend shape coefficient for authentication purposes by user expression-based authentication unit 130. For example, in some embodiments, blend shape coefficient values 252 may be whole numbers greater than or equal to zero, the enumeration of which depends on the number of blend shape coefficients (as illustrated by way of example in FIG. 5A and FIG. 5B). In some embodiments, a scale factor in the scale factors 253 is a numerical value assigned to the blend shape coefficient to determine whether the user expression is a valid user expression (e.g., a valid facial expression or a valid motion). For example, in some embodiments, scale factors 253 may be decimal values ranging from zero to one, depending on the assigned value by user expression-based authentication unit 130 (as illustrated by way of example in FIG. 5A and FIG. 5B).

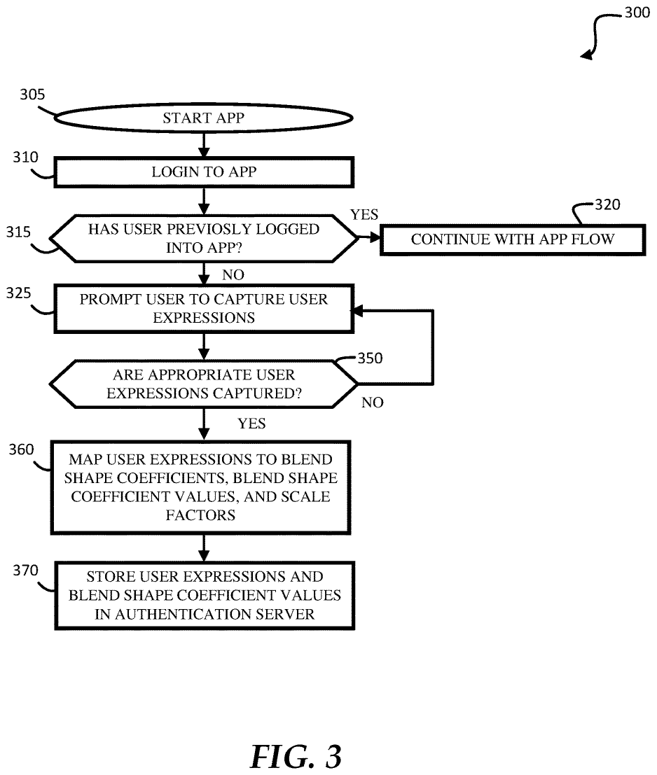

In some embodiments, a scale factor threshold 271 is a threshold value set by, for example, a developer of application 191, system 100, or more specifically, the user expression-based authentication unit 130, that is configured to serve as a threshold that is utilized by the user expression-based authentication unit 130 to indicate whether a user expression captured by the user device 190 is a valid user expression. For example, in some embodiments, for a scale factor threshold of 0.3, a user expression of the user received by the user expression-based authentication unit 130 may not be assessed by the user expression-based authentication unit 130 as being a valid user expression unless the scale factor value is greater than the scale factor threshold of 0.3. In some embodiments, the blend shape coefficients assigned to the user expressions or the sequence of user expressions (as illustrated in FIG. 3) and the blend shape coefficient assigned to an authentication user expression or sequence of authentication user expressions provided during authentication of the user (as illustrated in FIG. 4) are utilized by user expression-based authentication unit 130 to authenticate the user of the user device 190.

In some embodiments, the blend shape coefficient mapping unit 213 is executable code configured to map a user expression to the blend shape coefficient and the blend shape coefficient value as illustrated in, for example, user expression blend shape coefficient table 221 of FIG. 5A and FIG. 5B. In some embodiments, the blend shape coefficient mapping unit 213 is configured to map a comparison user expression to a comparison blend shape coefficient, a comparison blend shape coefficient value, and a comparison scale factor. In some embodiments, the blend shape coefficient mapping unit 213 is configured to map an authentication user expression to an authentication blend shape coefficient, an authentication blend shape coefficient value, and an authentication scale factor. In some embodiments, a comparison user expression is a user expression received from user device 190 and stored in memory 105 for comparison by user expression comparison unit 212 to an authentication user expression received during authentication of the user of application 191 of the user device 190. In some embodiments, the authentication user expression is a user expression received from user device 190 during authentication of the user of application 191 of the user device 190 that is utilized to authenticate the user of the application 191 of the user device. In some embodiments, the authentication user expression (or associated authentication blend shape coefficient values) is compared by user expression comparison unit 212 to a stored comparison user expression (or associated comparison blend shape coefficient values) in order to authenticate the user of application 191 of the user device.

In some embodiments, the user expression comparison unit 212 is executable code configured to determine whether an authentication user expression or a sequence of authentication user expressions match with a comparison user expression or a sequence of comparison user expressions. In some embodiments, the user expression comparison unit 212 is configured to compare a stored comparison user expression or a stored sequence of comparison user expressions to an authentication user expression or a sequence of authentication user expressions. In some embodiments, the user expression comparison unit 212 may be configured to compare a comparison coefficient value mapped to a comparison user expression (or comparison coefficient values mapped to a sequence of comparison user expressions) to an authentication coefficient value mapped to an authentication user expression (or authentication coefficient values mapped to a sequence of authentication user expressions). In some embodiments, user expression comparison unit 212 is configured to determine whether a sequence of authentication user expressions match with a sequence of comparison user expressions provided by the user of user device 190 as a password. In some embodiments, the user expression request unit 211, the user expression comparison unit 212, and the blend shape coefficient mapping unit 213 are collectively configured to perform user expression-based authentication to authenticate a user of a user device 190 as described further herein.

FIG. 3 is a flow diagram illustrating a user expression-based mapping method 300 in accordance with some embodiments. In some embodiments, the user expression-based mapping method 300 is a method utilized by the user expression-based authentication unit 130 to map user expressions to blend shape coefficients 251, blend shape coefficient values 252, and scale factors 253 that are utilized to authenticate the user of the user device 190. In some embodiments, the user expression-based authentication unit 130 is configured to perform the user expression-based mapping method 300. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the user expression-based mapping method 300 is described with reference to the figures described herein.

In some embodiments, at operation 305, a user of a user device 190 selects an application 191 on (e.g., a financial application, etc.) and logs into the application 191 at operation 310. In some embodiments, after logging into the application 191 at operation 310, at operation 315, the user expression-based authentication unit 130, via, application 191, determines whether the user has previously logged into the application 191. In some embodiments, user expression-based authentication unit 130 determines whether the user has previously logged into the application 191 by evaluating cookies stored on the user device 190 or by evaluating records associated with the user stored on system 100 (which may be, for example, an authentication server). In some embodiments, at operation 320, when the user expression-based authentication unit 130 determines that the user has previously logged into the application at operation 315, operation 320 proceeds with normal application flow on application 191 as the user has previously been verified.

In some embodiments, at operation 325, when user expression-based authentication unit 130, via, for example, application 191, determines that the user has not previously logged into the application 191 (e.g., the user is logging into the application 191 for the first time), user expression request unit 211 of user expression-based authentication unit 130 requests, via, for example, a prompt on the application 191 of the user device 190, the user capture or record user expressions of the user for application and/or user device 190 authentication purposes. In some embodiments, user expression request unit 211 requests, via, for example, the prompt on the application 191 of the user device 190, the user capture or record user expressions of the user using capturing device 195 of user device 190.

In some embodiments, the user expressions requested by user expression request unit 211 via application 191 are, as stated previously, facial expressions or body motions of the user that are used by the authentication server to authenticate the user of the application 191 on the user device 190. For example, in some embodiments, the user expression may be a mouth pucker, a cheek puff, a nose sneer, or an open jaw or other user expression as exemplified in the user expression blend shape coefficient table 221 of FIG. 5A and FIG. 5B. Additional user expressions are illustrated by way of example in the user expression blend shape coefficient table 221 illustrated in FIG. 5A and FIG. 5B. In some embodiments, the user expression request unit 211, via application 191, may be configured to dictate the user expressions the user is required to capture using the user device 190. In some embodiments, the user expression request unit 211 may request that the user capture random expressions and subsequently map the user expressions to corresponding blend shape coefficients and blend shape coefficient values. In some embodiments, user expression-based authentication unit 130 is configured to recognize special characteristics of the user of the user device 190 and provide the services provided herein accordingly. For example, in some embodiments, user expression-based authentication unit 130 may recognize, via, for example, voluntary information provided by the user of the user device 190, that the user is a specially-abled user and thus notify the user based on the characteristics of the specially-abled user. For example, if the user is blind, the user expression-based authentication unit 130 may request the user expression by vibrating the user device or via audio component on the user device 190. In some embodiments, operation 325 proceeds to operation 350.

In some embodiments, at operation 350, user expression-based authentication unit 130 receives the user expressions from the user device 190 and determines whether the appropriate user expressions have been captured by capturing device 195. In some embodiments, a prompt may be provided to the user of the application 191 to determine whether the requested user expressions have been captured. In some embodiments, when user expression-based authentication unit 130 determines that the requested user expressions have not been captured, operation 350 proceeds to operation 325, to prompt user to capture user expressions until the requested user expressions are captured or the application 191 logs the user out of the application 191. In some embodiments, when user expression-based authentication unit 130 determines that the requested user expressions have been captured, operation 350 proceeds to operation 360.

In some embodiments, at operation 360, user expression-based authentication unit 130 maps, encodes, or associates the user expressions received from the user device 190 with blend shape coefficients, blend coefficient values, and scale factors assigned and/or enumerated by the user expression-based authentication unit 130. In some embodiments, as stated previously, the blend shape coefficients, blend shape coefficient values, and scale factors are assigned by the user expression-based authentication unit 130 to the user expressions that are used to authenticate the user expressions. For example, as illustrated user expression blend shape coefficient table 221 of FIG. 5A, when the user expression received by the user expression-based authentication unit 130 is recognized as being a puffed cheek or puffed cheeks, blend shape coefficient mapping unit 213 assigns the user expression a blend shape coefficient of “cheekPuff”, a blend shape coefficient value 5, and a scale factor that depends on the validity level of the received user expression. In some embodiments, after the user expressions are mapped to the blend shape coefficient values at operation 360, at operation 370, user expression-based authentication unit 130 stores the user expressions and blend shape coefficient values in memory 105 of the authentication server.

In some embodiments, after the user expressions, blend shape coefficients, blend shape coefficient values, and scale factors have been stored by user expression-based authentication unit 130, the user expressions, blend shape coefficients, blend shape coefficient values, and scale factors may be utilized by the user expression-based authentication unit 130 to authenticate the user using the user expression-based authentication methods described herein.

FIG. 4 is a flow diagram illustrating a user expression-based authentication method 400 in accordance with some embodiments. In some embodiments, the user expression-based authentication method 400 is a method utilized by user expression-based authentication unit 130 to authenticate a user of application 191 of user device 190. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the user expression-based authentication unit 130 is configured to perform the user expression-based authentication method 400 in accordance with some embodiments. In some embodiments, the user expression-based authentication method 400 is described with reference to the figures described herein.

In some embodiments, at operation 405, a user of user device 190 opens application 191 and logs into the application 191 at operation 410. In some embodiments, after logging into the application 191 at operation 410, at operation 415, the user expression-based authentication unit 130 determines whether multi-factor authentication (MFA) or two-factor authentication (2FA) is required. In some embodiments, user expression-based authentication unit 130 determines whether MFA or 2FA is required by assessing account information of the user of the user device 190 to determine whether an MFA or 2FA option was selected by the user of the user device 190 during an initial login to the application 191. In some embodiments, user expression-based authentication unit 130 may require MFA or 2FA based on a recognition by the user expression-based authentication unit 130 that fraudulent transactions may be occurring related to the user associated with the application 191 and/or user device 190. In some embodiments, a requirement of application 191 may be to utilize the MFA or 2FA, thus MFA or 2FA may be utilized by application 191 by default. In some embodiments, when user expression-based authentication unit 130 determines that MFA or 2FA is not required, user expression-based authentication unit 130 allows the user to utilize the application 191 without further authentication at operation 420.

In some embodiments, at operation 425, when user expression-based authentication unit 130 determines that MFA or 2FA is required, user expression request unit 211 of user expression-based authentication unit 130 requests, via, for example, a prompt on the application 191 of the user device 190, the user capture an authentication user expression or sequence of authentication user expressions using capturing device 195 to authenticate the user utilizing user expression-based authentication unit 130. For example, in some embodiments, the user expression-based authentication unit 130 may dictate to the user “Please provide an authentication user expression for authentication purposes”. In some embodiments, in turn, the user, using capturing device 195 of user device 190, captures the authentication user expression (or sequence of authentication user expressions) and the user expression-based authentication unit 130 receives the captured authentication user expression (or sequence of authentication user expressions) from user device 190. In some embodiments, the user expression-based authentication unit 130 may specify a specific authentication user expression/s required for capture by the user using capturing device 195. For example, the user expression-based authentication unit 130 may specify that a left eye blink is required for capture as a user expression, an open mouth is required for capture as a user expression, etc. In some embodiments, upon capturing of the authentication user expression from the user of the user device 190, the captured authentication user expression is provided to the user expression comparison unit 212 of user expression-based authentication unit 130. In some embodiments, operation 425 proceeds to operation 430.

In some embodiments, at operation 430, following a process similar to the process used to map the comparison user expression to comparison blend shape coefficients, blend shape coefficient values, and comparison scale factors, blend shape coefficient mapping unit 213 maps the authentication user expression/s to an authentication blend shape coefficient/s, an authentication blend shape coefficient value/s, and an authentication scale factor/s. In some embodiments, after performing the mapping operations, operation 430 proceeds to operation 440.

In some embodiments, at operation 440, upon receiving the authentication user expression or sequence of authentication user expressions, user expression comparison unit 212 of user expression-based authentication unit 130 assesses the authentication user expression and determines whether authentication user expression or sequence of authentication user expressions match the comparison user expressions of the user stored in memory 105.

In some embodiments, user expression comparison unit 212 determines whether authentication user expression (or sequence of authentication user expressions) match with a comparison user expression (or sequence of comparison user expressions) by comparing the authentication blend shape coefficient value associated with the received authentication user expression with the comparison blend coefficient value associated with comparison user expression stored in the user expression blend shape coefficient table 221 (illustrated by way of example FIG. 5A and FIG. 5B).

In some embodiments, at operation 445, when user expression comparison unit 212 determines that the authentication user expression or sequence of authentication user expressions do not match with the comparison user expressions represented in user expression blend shape coefficient table 221, user expression-based authentication unit 130 does not authenticate the user using the authentication user expression and proceeds to utilize user expression request unit 211 to request an additional authentication user expression/s for authentication of the user. In some embodiments, operation 445, operation 425, and operation 440 may repeat for a limited number of instances dictated by user expression-based authentication unit 130.

In some embodiments, at operation 450, when user expression comparison unit 212 determines that the authentication user expression or sequence of authentication user expressions match with user expressions represented in user expression blend shape coefficient table 221, user expression-based authentication unit 130 authenticates the user and proceeds to allow the user to utilize the application 191 or user device 190.

FIG. 5A and FIG. 5B illustrate a user expression blend shape coefficient table 221 in accordance with some embodiments. In some embodiments, as stated previously, the user expression blend shape coefficient table 221 represents user expressions mapped to blend shape coefficients 251, blend shape coefficient values 252, and scale factors 253. In some embodiments, for the user expression blend shape coefficient table 221 illustrated in FIG. 5A and FIG. 5B, there are fifty-one user expressions that have been mapped by user expression-based authentication unit 130 to fifty-one blend shape coefficients 510, fifty-one blend shape coefficient values 515, and fifty-one scale factors 520. For illustration purposes, a range of possible scaled factors for each blend shape coefficient (e.g., a range from 0 and 1) is illustrated as scale factors 520 in user expression blend shape coefficient table 221.

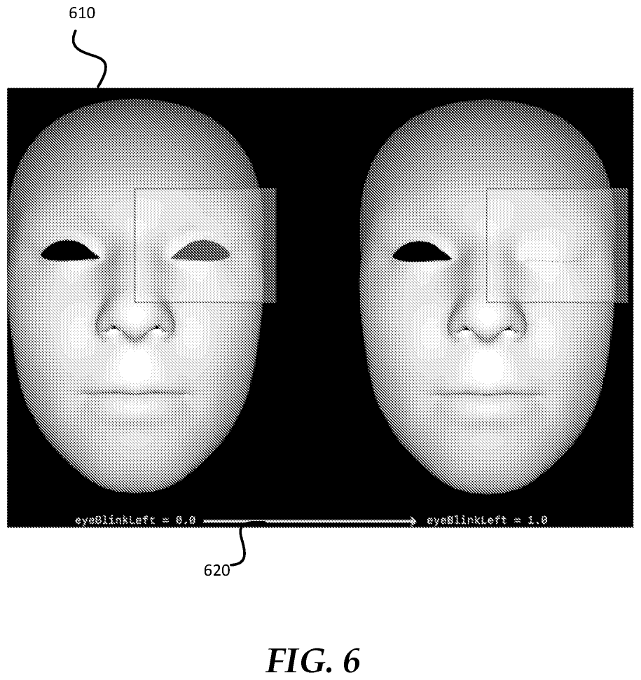

FIG. 6 illustrates a sequence of images 610 that represent a user expression of a user utilized to authenticate the user in accordance with some embodiments. For the example illustrated in FIG. 6, the user expression is a left eye blink user expression and is mapped to an eyeblinkleft blend shape coefficient and includes a visual representation of the associated scale factor 620. For the example illustrated in FIG. 6, the scale factor 620 is mapped by user expression-based authentication unit 130 to a value of 1 for the left eye blink user expression (e.g., eyeblinkleft blend shape coefficient) and the blend shape coefficient value is mapped to a value of 8. In some embodiments, the user expression-based authentication unit 130 utilized the user expression represented in FIG. 6 to authenticate the user of the user device 190 utilizing the methods described herein.

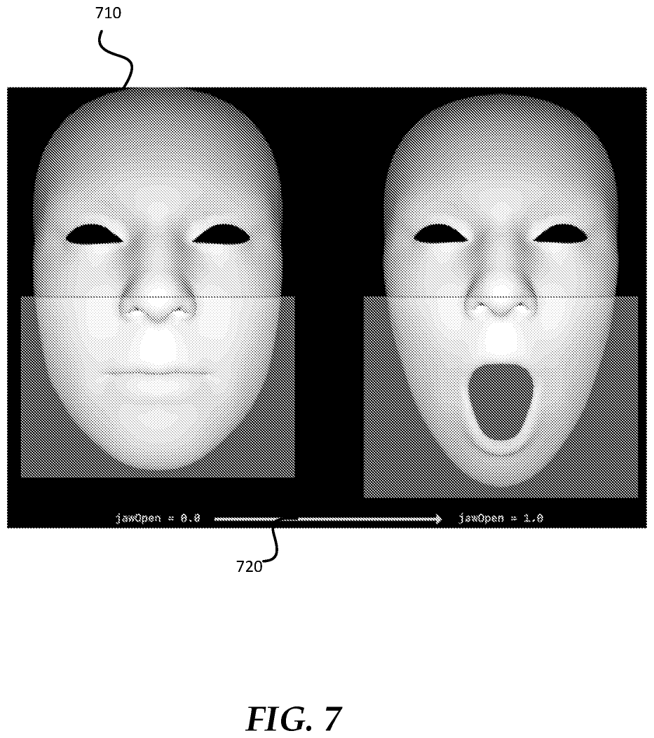

FIG. 7 illustrates a sequence of images 710 that represent a user expression of a user utilized to authenticate the user in accordance with some embodiments. For the example illustrated in FIG. 7, the user expression is an open jaw user expression and is mapped to a jaw open blend shape coefficient and includes a visual representation of the associated scale factor 720. For the example illustrated in FIG. 7, the scale factor 720 is mapped by user expression-based authentication unit 130 to a value of 1 for the open jaw user expression (e.g., jawOpen blend shape coefficient) and the blend shape coefficient value is mapped to a value of 24. In some embodiments, the user expression-based authentication unit 130 utilized the user expression represented in FIG. 7 to authenticate the user of the user device 190 utilizing the methods described herein.

In alternate embodiments, user expression-based authentication unit 130 may be configured to allow the user, via application 191, to select a specific sequence of user expressions as a password or for MFA/2FA (e.g., the user selects or sets a sequence of user expressions of the stored user expressions as a password in the authentication server). In some embodiments, the sequence of user expressions (represented utilizing blend shape coefficient values) may be utilized by user expression-based verification unit 130 for verification and authentication purposes (e.g., as a password or for MFA/2FA). For example, the user may utilize application 191 to select an open mouth, closed mouth, and left eye blink as the sequence of user expressions as a password or MFA/2FA. In some embodiments, when user expression request unit 211 requests the user input an MFA/2FA or password, the user must provide the correct sequence of user expressions as MFA/2FA or password (which is compared to the stored MFA/2FA or password by user expression comparison unit 212 as described previously herein).

In another example, user selects, using application 191, a sequence of user expressions as a password corresponding to an eyeBlinkLeft blend shape coefficient, a mouthSmileLeft blend shape coefficient, a mouthSmileRight blend shape coefficient, and a jawOpen blend shape coefficient. In some embodiments, after selection of the user expressions by the user of application 191, the user expressions are provided to the authentication server (e.g., system 100). In some embodiments, after receiving the selected sequence of user expressions, the authentication server maps each user expression of the sequence of user expressions to their corresponding blend shape coefficient values, (e.g., [8, 43, 44, 24]) and stores the sequence of user expressions as a password in the authentication server. In some embodiments, at the time of authentication of the password ay authentication server, each user expression is validated or authenticated by the authentication server using the mapped values by the authentication server.

In some embodiments, user may utilize any sequence of expressions between 0 to 50 as user expressions for a password. In some embodiments, using the methods described herein, the system 100 is able to provide greater combinations of passwords compared to traditional computer systems that typically utilize numbers in passwords ranging between 0 to 9.

In some embodiments, augmented reality (AR) technology may be utilized by the application 191 to track facial expressions and body motions of the user (which may be utilized for authentication purposes instead of traditional passwords or OTPs).

In some embodiments, in addition to facial expressions of the user being used for authentication purposes, users may use a combination of body motions and/or facial expressions for authentication. In some embodiments, utilization of the combination of body motions and/or facial expressions make fraudulent authentication by fraudsters more difficult, as the fraudsters and or computer system may not be able to guess the combination utilized for the password by the user. In some embodiments, augmented reality (AR) technology, such as a head mounted device (HMD), may be utilized to recognize and track a movement of a user using, for example, a rear camera of a mobile device. In some embodiments, AR applies the detected motion to a three-dimension (3D) character model in real time. In some embodiments, the body motion may be validated using, for example, a location of a joint that makes up a skeleton of a user and the location of the joint relationship with other joints.

In some embodiments, a scale factor with a value of 0 is considered “neutral” (e.g., the user expression captured by the user device 190 is not considered a valid user expression) and a scale factor with a value greater than 0.3 is considered a valid user expression.

In some embodiments, a computer-implemented method includes requesting, from an authentication server, a comparison user expression from a user of an application of a user device; mapping the comparison user expression to a comparison blend shape coefficient and a comparison blend shape coefficient value at the authentication server; requesting, from the authentication server, an authentication user expression from the user of the application on the user device; mapping the authentication user expression to an authentication blend shape coefficient and an authentication blend shape coefficient value at the authentication server; and utilizing the authentication user expression and the comparison user expression to authenticate the user of the user device.

In some embodiments of the computer-implemented method, utilizing the authentication user expression and the comparison user expression to authenticate the user of the user device includes comparing the authentication user expression to the comparison user expression stored in the authentication server.

In some embodiments of the computer-implemented method, the user of the user device is authenticated when the authentication user expression matches the comparison user expression.

In some embodiments of the computer-implemented method, the comparison blend shape coefficient value is a whole number value that maps to the comparison blend shape coefficient and the authentication blend shape coefficient value is a whole number that maps to the authentication blend shape coefficient.

In some embodiments, the computer-implemented method further includes mapping the comparison user expression to a scaling factor.

In some embodiments, the computer-implemented method further includes utilizing the scaling factor to determine whether the comparison user expression is a valid user expression.

In some embodiments of the computer-implemented method, the scaling factor is a decimal value ranging from zero to one.

In some embodiments of the computer-implemented method, utilizing the authentication user expression and the comparison user expression to authenticate the user of the user device includes comparing the authentication blend shape coefficient value to the comparison blend shape coefficient value stored in the authentication server.

In some embodiments, a system includes a processor; and a non-transitory computer readable medium coupled to the processor, the non-transitory computer readable medium comprising code that: requests a comparison user expression from a user of an application of a user device; maps the comparison user expression to a comparison blend shape coefficient and a comparison blend shape coefficient value; requests an authentication user expression from the user of the application on the user device; maps the authentication user expression to an authentication blend shape coefficient and an authentication blend shape coefficient value; and utilizes the authentication user expression and the comparison user expression to authenticate the user of the user device.

In some embodiments of the system, the non-transitory computer readable medium includes code that: utilizes the authentication user expression and the comparison user expression to authenticate the user of the user device includes comparing the authentication user expression to the comparison user expression.

In some embodiments of the system, the non-transitory computer readable medium includes code that: authenticates the user of the user device when the authentication user expression matches with the comparison user expression.

In some embodiments of the system, the comparison blend shape coefficient value is a whole number value that maps to the comparison blend shape coefficient.

In some embodiments of the system, the authentication blend shape coefficient value is a whole number that maps to the authentication blend shape coefficient.

In some embodiments of the system, the non-transitory computer readable medium includes code that: maps the comparison user expression to a scaling factor.

In some embodiments the system, the scaling factor is utilized to determine whether the comparison user expression is a valid user expression.

In some embodiments of the system, the scaling factor is a decimal value ranging from zero to one.

In some embodiments of the system, the authentication user expression is compared to the comparison user expression stored using an artificial intelligence or machine learning technique.

In some embodiments, a user expression-based authentication unit includes a user expression request unit; a blend shape coefficient mapping unit coupled to the user expression request unit; and a user expression comparison unit coupled to the blend shape coefficient mapping unit, wherein based upon an authentication comparison between a comparison user expression and an authentication user expression utilizing a comparison blend shape coefficient value and an authentication blend shape coefficient value, the user expression-based authentication unit authenticates a user of an application on a user device.

In some embodiments of the user expression-based authentication unit, the blend shape coefficient mapping unit maps the comparison user expression to the authentication blend shape coefficient value and the authentication user expression to the authentication blend shape coefficient value.

In some embodiments of the user expression-based authentication unit, the user of the application is authenticated when the comparison blend shape coefficient value matches the authentication blend shape coefficient value.

What is claimed is:

1. A computer-implemented method, comprising:
requesting, from an authentication server, a comparison user expression from a user of an application of a user device;
mapping the comparison user expression to a comparison blend shape coefficient and a comparison blend shape coefficient value at the authentication server;
requesting, from the authentication server, an authentication user expression from the user of the application on the user device;
mapping the authentication user expression to an authentication blend shape coefficient and an authentication blend shape coefficient value at the authentication server; and
utilizing the authentication user expression and the comparison user expression to authenticate the user of the user device.

2. The computer-implemented method of claim 1, wherein:
utilizing the authentication user expression and the comparison user expression to authenticate the user of the user device includes comparing the authentication user expression to the comparison user expression stored in the authentication server.

3. The computer-implemented method of claim 2, wherein:
the user of the user device is authenticated when the authentication user expression matches the comparison user expression.

4. The computer-implemented method of claim 3, wherein:
the comparison blend shape coefficient value is a whole number value that maps to the comparison blend shape coefficient and the authentication blend shape coefficient value is a whole number that maps to the authentication blend shape coefficient.

5. The computer-implemented method of claim 4, further comprising:
mapping the comparison user expression to a scaling factor.

6. The computer-implemented method of claim 5, further comprising:
utilizing the scaling factor to determine whether the comparison user expression is a valid user expression.

7. The computer-implemented method of claim 6, wherein:
the scaling factor is a decimal value ranging from zero to one.

8. The computer-implemented method of claim 1 wherein:
utilizing the authentication user expression and the comparison user expression to authenticate the user of the user device includes comparing the authentication blend shape coefficient value to the comparison blend shape coefficient value stored in the authentication server.

9. A system, comprising:
a processor; and
a non-transitory computer readable medium coupled to the processor, the non-transitory computer readable medium comprising code that:
requests a comparison user expression from a user of an application of a user device;
maps the comparison user expression to a comparison blend shape coefficient and a comparison blend shape coefficient value;
requests an authentication user expression from the user of the application on the user device;
maps the authentication user expression to an authentication blend shape coefficient and an authentication blend shape coefficient value; and
utilizes the authentication user expression and the comparison user expression to authenticate the user of the user device.

10. The system of claim 9, wherein:
the non-transitory computer readable medium includes code that:
utilizes the authentication user expression and the comparison user expression to authenticate the user of the user device includes comparing the authentication user expression to the comparison user expression.

11. The system of claim 10, wherein:
the non-transitory computer readable medium includes code that:
authenticates the user of the user device when the authentication user expression matches with the comparison user expression.

12. The system of claim 11, wherein:
the comparison blend shape coefficient value is a whole number value that maps to the comparison blend shape coefficient.

13. The system of claim 12, wherein:
the authentication blend shape coefficient value is a whole number that maps to the authentication blend shape coefficient.

14. The system of claim 13, wherein:
the non-transitory computer readable medium includes code that:
maps the comparison user expression to a scaling factor.

15. The system of claim 14, wherein:
the scaling factor is utilized to determine whether the comparison user expression is a valid user expression.

16. The system of claim 15, wherein:
the scaling factor is a decimal value ranging from zero to one.

17. The system of claim 16, wherein:
the authentication user expression is compared to the comparison user expression stored using an artificial intelligence or machine learning technique.

18. A user expression-based authentication unit, comprising:
a user expression request unit;
a blend shape coefficient mapping unit coupled to the user expression request unit; and
a user expression comparison unit coupled to the blend shape coefficient mapping unit, wherein based upon an authentication comparison between a comparison user expression and an authentication user expression utilizing a comparison blend shape coefficient value and an authentication blend shape coefficient value, the user expression-based authentication unit authenticates a user of an application on a user device.

19. The user expression-based authentication unit of claim 18, wherein:
the blend shape coefficient mapping unit maps the comparison user expression to the authentication blend shape coefficient value and the authentication user expression to the authentication blend shape coefficient value.

20. The user expression-based authentication unit of claim 19, wherein:
the user of the application is authenticated when the comparison blend shape coefficient value matches the authentication blend shape coefficient value.
